(19) United States
(12) Patent Application Publication
(10) Pub. No.: US 2024/0013325 A1
(43) Pub. Date: Jan. 11, 2024

(54) METHODS AND DEVICES FOR INTEGRATING PARCEL INFORMATION

(71) Applicant: Block X, Inc., Houston, TX (US)

(72) Inventors: Mohamad Farran, Portage, MI (US); Stephen Garza, Houston, TX (US)

(21) Appl. No.: 18/216,185

(22) Filed: Jun. 29, 2023

Related U.S. Application Data
(60) Provisional application No. 63/358,593, filed on Jul. 6, 2022.

(51) Int. Cl. G06Q 50/16

(52) U.S. Cl. CPC G06Q 50/163

(57) ABSTRACT

The invention provides systems and methods that integrate information about real estate parcels in an intuitive and useful manner. A server system causes a user device to depict real estate parcels drawn on a map view, in which each parcel is drawn with precise boundaries and with dimensional information presented within the view. The displayed parcels are also shown with flood risk information that allows a user to see, at a granular level of detail, how different specific areas within any given parcel are affected by flood risks and associated regulatory restrictions. A device for displaying integrated property information may be a smartphone or computer that includes instructions to cause the display to present a graphical user interface depicting real property information including a map depicting roads, land-water boundaries, real estate parcels drawn onto the map; numerical measures of dimension, and flood risk information.

### CROSS-REFERENCE TO RELATED APPLICATIONS

This application claims priority to, and the benefit of, U.S. Provisional Application No. 63/358,593, filed on Jul. 6, 2022, the content of which is incorporated by reference herein in its entirety.

### TECHNICAL FIELD

The invention relates to systems that integrate parcel information.

### BACKGROUND

Some electronic systems exist to support or facilitate real estate shopping. For example, U.S. Pat. No. 10,867,002 describes a system that allows a user to browse listings by neighborhood. In another example, U.S. Pat. No. 11,061,985 reports a system that looks for parcels with addresses that “bracket” the address of a given parcel of interest to identify a community of real estate parcels. Those systems are meant to aid buyers or brokers in finding real estate parcels.

Buyer-facing systems are typically, logically, limited to active listings. Broker-facing systems are often proprietary so that only company insiders can use the resources. In fact, those points illustrate the nature of the world of real estate parcel information today. Relevant information is fractionated with many components being kept proprietary by corporate entities or held by government entities in systems that are difficult to access. Some of the most user-friendly systems are online real-estate marketplaces where available information is limited to for-sale listings with only limited information such as asking prices and subjective promotional labels such as “hot home.”

### SUMMARY

The invention provides systems and methods that integrate information about, and relevant to, real estate parcels and present the integrated information in an intuitive and useful manner. Importantly, systems and methods of the invention allow users to see real estate parcels drawn on a map view, wherein each parcel is drawn with precise boundaries and with dimensional information presented within the view. Additionally, the map view and the displayed parcels are shown with certain categories of flood risk information that allows a user to see, at a granular level of detail, how different specific areas within any given parcel are affected by flood risks and associated regulatory restrictions. The map view, with precisely-drawn parcels and flood risk information, is presented in an interface that may further include other information such as estimates of traffic levels, property record information, and contact information for owners. Preferably, systems of the invention are not specific to active listings. In fact, information integration by systems of the invention is useful to people making any study of or decisions about real estate and not just to people trying buy and sell a property.

Preferred embodiments of the invention use a server computer system that works with mapping software and obtains data from third-party sources and calculates and renders those data for display on, or overlayed upon, a map from the mapping software. The display is by the graphical user interface of a user device such as a computer or smartphone. A smartphone is a preferred embodiment because users are likely to have such a device while “in the field” and upon visiting a neighborhood in-person can pull up the map on the interface to see parcels, parcel dimensions, and flood risks. The interface can display a rich amount of additional information including, for example, zoning codes (or links thereto), estimated traffic levels, tax and sale histories, parcel owners, environmental hazards or designations, and other such information. The user enjoys all of this information being presented together in an integrated manner on a single tool. As one example that well illustrates the usefulness of the system, the map view can depict flood risk and associated information from multiple different categories. Specifically, in this example, the map view and depict a flood plain, such as the 100 year floodplain, and also depict the precise locations of regulatory floodways. A regulatory floodway may not strictly lie within a given floodplain yet nevertheless is designation as a regulatory floodway may restrict development in a manner of great interest to a person interested in real estate parcels. Because floodways and floodplains can be shown in the map view on the interface, two parcels that otherwise appear nearly identical may be discovered to offer very different potentials and interest.

Systems of the invention also integrate and display information about parcel owners. In preferred embodiments, owner information is available on an opt-in basis and/or parcel owner information is filtered using tools such as a do-not-disturb list or a do-not-call registry. For unfiltered owners who opt-in, parcels displayed in the map view can include owner contact information or links to such information. A user interested in a parcel may contact an owner using the contact information or via direct messaging within the system of the invention. Additionally, parcel records can link to or display information about vendors and services such as local and relevant insurance companies, title search companies, real estate closing attorneys, or mortgage lenders. Systems of the invention may include or link to a rich variety of other information such as property pictures (“street view” images, past listings, or user uploads), census data or area demographics, applicable zoning, crime statistics, real estate prices or trends therein, weather and climate data, or other information. Thus users of the system may identify parcels that they wish to purchase (or not) and may even contact owners and it is possible that sales may occur. However, it is not a principal objective of systems of the invention to be a real estate marketplace. Rather, the invention uses a server computer system to calculate and render displayable information integrated with each other on a map view using raw data from disparate sources.

In certain aspects, the invention provides a device for viewing integrated property information. The device may be a smartphone, tablet, personal computer or laptop. The device includes a processor coupled to a display device and a tangible memory subsystem. The memory subsystem includes instructions executable by the processor to cause the display device to present a graphical user interface depicting real property information. The depicted real property information includes at least a portion of a geographic map of land, the map depicting roads present on the land and land-water boundaries, a plurality of real estate parcels shown by parcel boundary lines drawn onto the map; and a numerical measure of a length displayed along one or more of the parcel boundary lines. The depicted real property information may further include flood risk at locations on the map of the land. The flood risk may be depicted as a floodplain superimposed on the geographic map, the floodplain at least showing an area deemed to lie within, e.g., a 100 year floodplain. In some embodiments, the flood risk is depicted using curves to mark a perimeter of the one hundred year floodplain so that, for at least one of the parcels, a user may see portions of the parcel within the one hundred year floodplain and portions outside of the one hundred year floodplain, optionally also including curves for a 500 year or other floodplains. In certain embodiments, the real property information further includes floodway markings to indicate designated floodways, such that the floodway markings are visually distinct from the floodplain.

The instructions may be executable to cause the device to send user queries to, and receive the real property information from, a remote server computer system that obtains parcel data for the real estate parcels from a data provider and executes an integration module to transform the parcel data into the parcel boundary lines as drawn on the map. The obtained parcel data may include a parcel boundary as a geometric shape file, and the remote server computer system may calculate parcel dimensions for display on the map. Optionally the device is operable to obtain, from a remote server system, records of levels of cell tower activity and to display activity levels on the map based on the levels of cell tower activity. For example, the remote server system may transform the levels of cell tower activity into an estimate of traffic levels on the map and cause the device to display the estimated traffic levels on the map.

In various embodiments, the device is operable to obtain, from a remote server system, a record of an environmental hazard on the land (e.g., a superfund designation or a buried gas tank or a former dry cleaner) and place a mark on the map showing a location of the environmental hazard. The depicted real property information may include owner information, or a link to the owner information, for parcels shown drawn onto the map. For example, the instructions may cause the device to send user queries to, and receive the real property information from, a remote server system that maintains a parcel owner database, in which the owner information is made available to a user of the device for an owner that has opted in to having their information shared on the device. Optionally, the owner information accessible via the device is filtered to exclude persons listed on a do-not call-registry or a do-not-disturb list. The graphical user interface may include a search tool via which a user may enter search terms to inform what depicted real property information is depicted (e.g., key in address, or zip code, or hit “near me”). The device may be operable to depict, for at least one of the plurality of real estate parcels, information showing or linking to at least one: applicable zoning code; local demographic data; local climate zone or classification. The device may be operable to, for at least one of the plurality of real estate parcels, link a user to property records including one or more of a deed, a lien, a property tax rate, a recorded interest, and a mortgage. The device may be operable to provide a user with links to a service provider optionally selected from an architect, a land surveyor, an environmental studies firm, optionally searchable by an address of a selected parcel.

In certain embodiments, the remote server comprises a web services network that makes a quantity of cloud computing resources available to the integration module in proportion to the quantity of parcel data being transformed, i.e., spins up more boxes when demand spikes.

Aspects of the invention provide a method for providing integrated property information. The method includes obtaining, at a server computer system, parcel data for a plurality of real estate parcels from a data provider; transforming, via a integration module on the server computer system, the parcel data into the parcel boundary line files capable of being as drawn on the map of land where the real estate parcels are located; calculating, by the server computer system, dimensions that include at least a numerical measure of a length for at least one parcel boundary line; and transmitting, to a user device, real property information to be displayed via a graphic interface on the user device. Those steps cause the user device to display at least a portion of the geographic map of land, at least one real estate parcel shown by parcel boundary lines drawn onto the map; and the numerical measure of a length displayed along the one parcel boundary line. Preferably the integration module further adds to the map flood risk information at locations on the map of the land. The flood risk may be depicted as a floodplain superimposed on the geographic map, the floodplain at least showing an area deemed to lie within a 100 year floodplain. The method may include causing the user device to depict the flood risk using curves to mark a perimeter of the one hundred year floodplain so that, for at least one of the parcels, a user may see portions of the parcel within the one hundred year floodplain and portions outside of the one hundred year floodplain. The method may include operating the user device to depict floodway markings to indicate designated floodways, wherein the floodway markings are visually distinct from the floodplain. In some embodiments, the method includes receiving, via the integration module, parcel data that includes a parcel boundary as a geometric shape file, and calculating parcel dimensions for display on the map. The method may include obtaining records of levels of cell tower activity and calculating activity levels at locations on the map based on the levels of cell tower activity. The method may include transforming the levels of cell tower activity into an estimate of traffic levels on the map and causing the user device to display the estimated traffic levels on the map. In some embodiments, the method includes marking, by the server computer system, the map to show a location of an environmental hazard. In certain embodiments, the server computer system comprises a web services network that makes available a quantity of cloud computing instances in proportion to the quantity of parcel data being transformed. The method may include attaching, by the integration module, owner information, or a link to the owner information, for at least one of the real estate parcels to be shown drawn onto the map. The method may include causing, by the server computer system, the user device to provide, for at least one of the plurality of real estate parcels: applicable zoning code; local demographic data; local climate zone or classification; a property record transaction record, optionally wherein a property transaction record includes a deed, a lien, a property tax rate, a recorded interest, or a mortgage; or a link to a professional services provider.

Related aspects provide system for providing integrated property information. The system include one or more server computers operable to perform steps of any embodiment of a method described above.

### BRIEF DESCRIPTION OF THE DRAWINGS

FIG. 1 shows a device for viewing integrated property information.

FIG. 2 shows a section of the map that includes a residential area.

FIG. 3 shows a real estate parcel with a numerical measure of dimension.

FIG. 4 shows the depiction of flood risk at locations on the map.

FIG. 5 depicts a system of the invention.

FIG. 6 shows an input mechanism.

FIG. 7 shows a specific residential parcel.

FIG. 8 shows property data that may be retrieved and displayed.

FIG. 9 shows a square footage value that is calculated by the server computer system.

FIG. 10 shows an interface that gives dollar values calculated.

FIG. 11 shows a transition from a parcel-view to owner contact information.

FIG. 12 diagrams a method for providing integrated property information.

### DETAILED DESCRIPTION

Systems and methods of the invention integrate information relevant to parcels of real estate by pulling raw digital data from a number of disparate sources and applying computer programming to calculate and render relevant information in an integrated manner. The data may be publicly available but otherwise only available through diverse different resources including online and in-person databases, registries, maps, and pictures. Systems of the invention in particular calculate and display the dimensions and boundaries of discrete parcels of real estate including displaying those boundaries on a digital map view with dimensions shown numerically to the tenth and even the hundredth of foot or meter. While numerous disparate categories of information are obtained and integrated by systems of the invention, flood risk information as presented herein is one important example. Systems of the invention include a device, such as a smartphone, that is caused to display a map of land with real estate parcels rendered by boundaries thereupon. The map also includes flood risk information such as the contoured lines of a 100 year flood plain. Notably, the actual boundary of the floodplain is displayed along with the actual boundary of one or more real estate parcels. This permits a user to evaluate different areas of a parcel across and within the extent of the parcel. For example, a user may be considering purchasing 20 acres with the purpose of a building a few cottages. The user may be unwilling or unable to build within a certain floodplain due to regulatory reasons, insurance provisions, or personal preferences. The flood risk information shows over the 20 acre parcel what different sub parts are and are not available for building according to those criteria. Other features may be displayed and are within the scope of this disclosure as discussed herein.

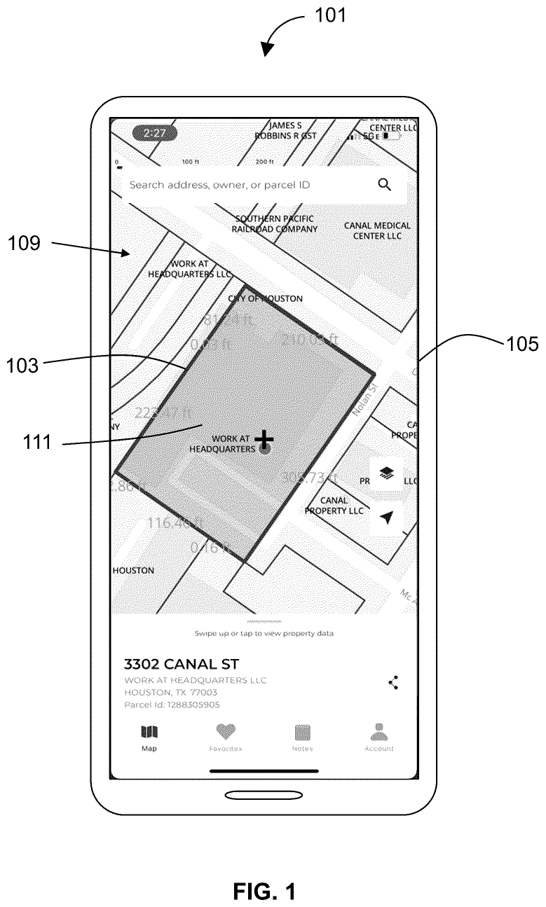

FIG. 1 shows a device 101 for viewing integrated property information. The device 101 includes a processor coupled to a display device 105 and a tangible memory subsystem comprising instructions executable by the processor to cause the display device 105 to present a graphical user interface depicting real property information. The device 101 may be a computer, such as a laptop or desktop computer. The device 101 may be a table computer or, as shown, a smartphone. As shown, the depicted real property information includes at least a portion of a geographic map 109 of land. Preferably the map shows features present on the land such as roads, structures, land-water boundaries (i.e., rivers, lakes, and oceans), and other features of interest. In the depicted view, a parcel 103 is highlighted and a building 111 (with walls substantially parallel to the boundaries of the parcel 103) appears as a rectangle that is darker than the surrounding area. The device 101 gives a measurement of a length of each boundary of the parcel 103. For example, the North-East facing edge is shown to be 210.05 feet, with “210.05 ft” being rendered on the screen of the device overlapping that edge. The device 101 is in communication with a server computer system that calculates the dimension. The display device 105 may be a touchscreen (e.g., a capacitive touch screen) allowing a user to pinch to zoom and swipe to pan in the manner familiar to smartphone users. For example, in the depicted view, a user could swipe to the left on the screen, thereby panning the view of the map 109 that is being shown. For example, by panning W×NW about 2 miles, e.g., in a single swipe, a user may shift the view from the depicted commercial district to a residential area.

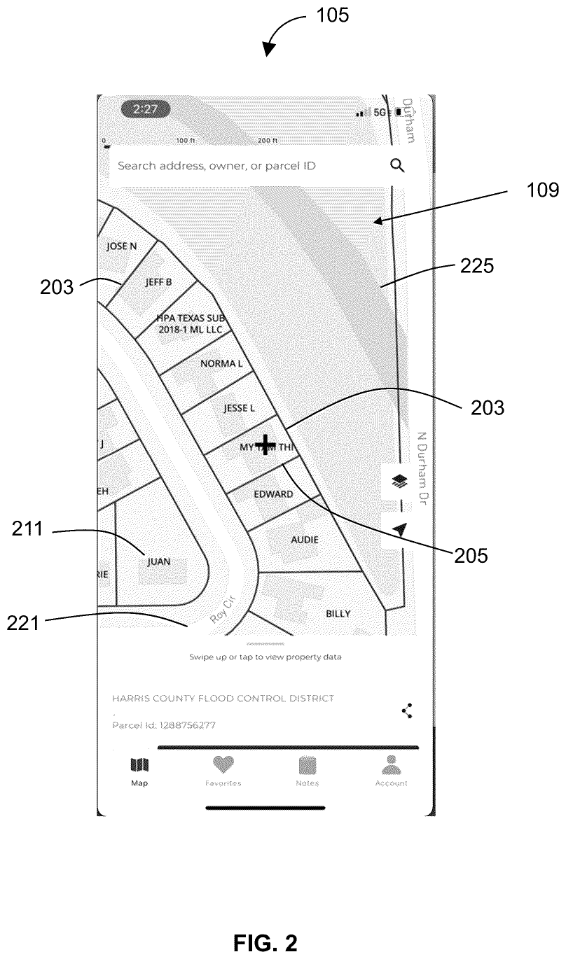

FIG. 2 shows another section of the map 109 that includes a residential area being shown on the display device 105. After panning to (or zooming in to, or searching and selecting) this residential area, the server computer system may calculate and render a plurality of real estate parcels 203 that are present in that area. Thus, here, the real property information that is depicted on the display device 105 includes the plurality of real estate parcels 203 shown by parcel boundary lines 205 drawn onto the map. Other features being shown include a road 221 (“Roy Cir”) and a land-water boundary 225 (here, the bank of a stream). Such features may simply be obtained at least in part from the source map. Another feature shown is an owner label 211. Owner labels 211 may give the names of owners, or the names of owners who have opted-in, or links to owner information, such as links that pull up an in-system file with owner information or hyperlinks to other information. One important feature of embodiments of the disclosure is the calculating, rendering, and depiction of parcels 203 and their dimensions.

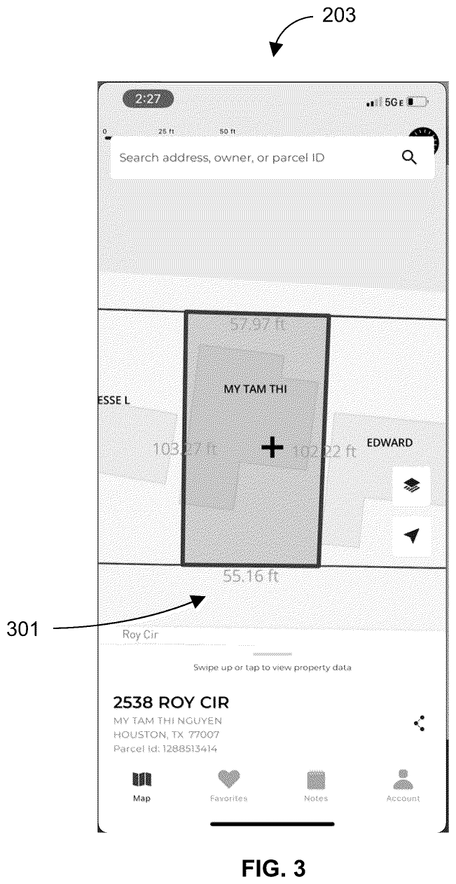

FIG. 3 shows that a real estate parcel 203 may be depicted along with a numerical measure 301 of a length displayed along one or more of the parcel boundary lines. In preferred embodiments, systems of the disclosure use a server computer system that obtains real estate parcel information. Data useful for displaying parcels 203 and numerical measures 301 of parcel dimensions may be obtained from a third-party vendor such as Real Estate Portal, USA, using methods as described in U.S. Pat. No. 8,255,418, incorporated by reference. Here, the server computer system may be, for example, provided by cloud computing services such as web servers offered with on-demand availability by a service such as Amazon Web Services (AWS). Use of AWS or a similar service may be beneficial as there is no need to maintain idle computers. Instead, the cloud service provider will connect and activate as many server instances as the task instantaneously demands. Here, the server computer system within the system of the invention receives raw data for parcels from the third party vendor. Those data may be received as, e.g., georeferenced polygon files. The server computer system preferably calculates all dimensional data and also, with reference to the map of the land that will be displayed on the device 101, renders the parcel data as parcels 203 to be depicted by parcel boundary lines 205 on the map along with the calculated numerical measurements 301 of length. The server computer system may calculate any relevant dimension value including for example, area of a parcel, elevation change, plan view area, total surface area (a parcel on a steep slope will have a great surface area than its plan view area), boundary lengths, lengths of shared boundaries, lengths of land-water boundaries, and other values. The server computer system composites the parcels boundary lines with the map and sends that for display by the device 101, as shown. As shown, the device displays numerical values of boundary lengths (e.g., 55.16 ft for boundary along bottom of screen). Another important features of the device 101 is that the depicted real property information further includes flood risk at locations on the map of the land.

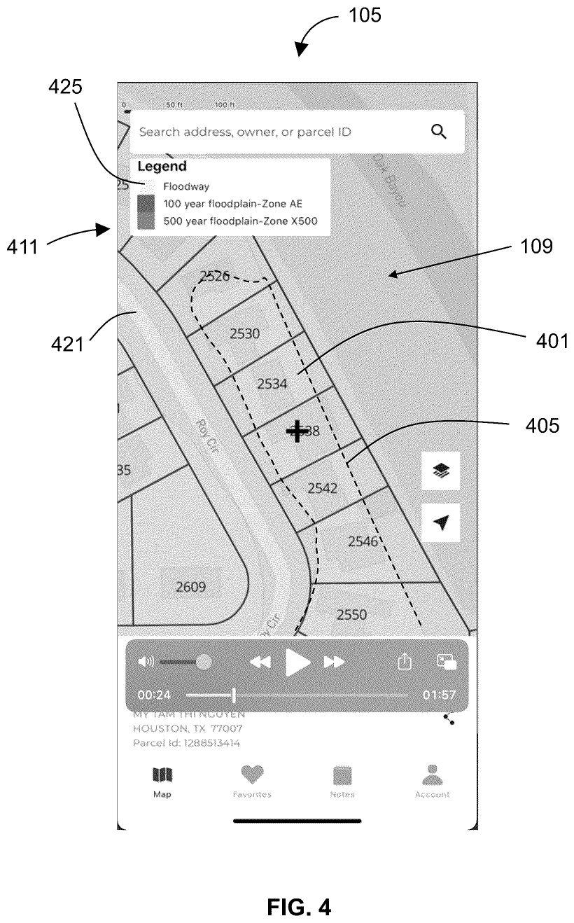

FIG. 4 shows the depiction of flood risk at locations on the map 109 of the land.

Specifically, the flood risk may be depicted as a floodplain 401 superimposed on the geographic map 109. The floodplain 401 may show, for example, an area deemed to lie within a 100 year floodplain. Here, the 100 year and the 500 year flood plains are color coded although in the view shown, nothing lies within the 100 year flood plan. The “finger” of different shading bounded by a dashed-line curve 405 that extends over house numbers (from the bottom) 2550, 2546, 2542, 2538, 2534, 2530, and into 2526 is the 500 year floodplain. In the depicted view, house numbers are shown, so the flood plain only partially extends into the property located at 2526. Roy Cir. That illustrates an important feature of the invention. Systems and methods of the invention give granular and specific detail about flood risk including specific areas of risk within a parcel. As can be seen, the flood risk is depicted using curves 405 to mark a perimeter of the 500 year floodplain so that, for at least one of the parcels, a user may see portions of the parcel within the 500 year floodplain and portions outside of that. The depicted information may also include curves 405 for a 100 year floodplain 411. Another important feature related to flood risk information is that systems and methods of the invention may display real property information that includes floodway markings 421 to indicate designated, or regulatory, floodways 425, wherein the floodway markings are visually distinct from the floodplain. A regulatory floodway may not (and likely will not) coincide precisely with any specific floodplain. In some instances, a floodplain is a natural feature, although calculated or measured by humankind, whereas a regulatory floodway is a product of agency action. A regulatory floodway may come with prohibitions on construction (regardless of actual flood risk) deemed necessary for regional water management. Preferably, the server computer system obtains flood risk information including floodplain maps and floodway locations from third-party services that may include Federal or state emergency management agencies. The server computer system references those features to the map 109 and renders those flood risk features in a composite manner integrated onto the map 109 allowing a user to view that information. While shown so far in terms of a user device 101 such as smartphone, and it user interface 105, such as a capacitance touchscreen, the device 101 operates as a part of a larger system of the invention.

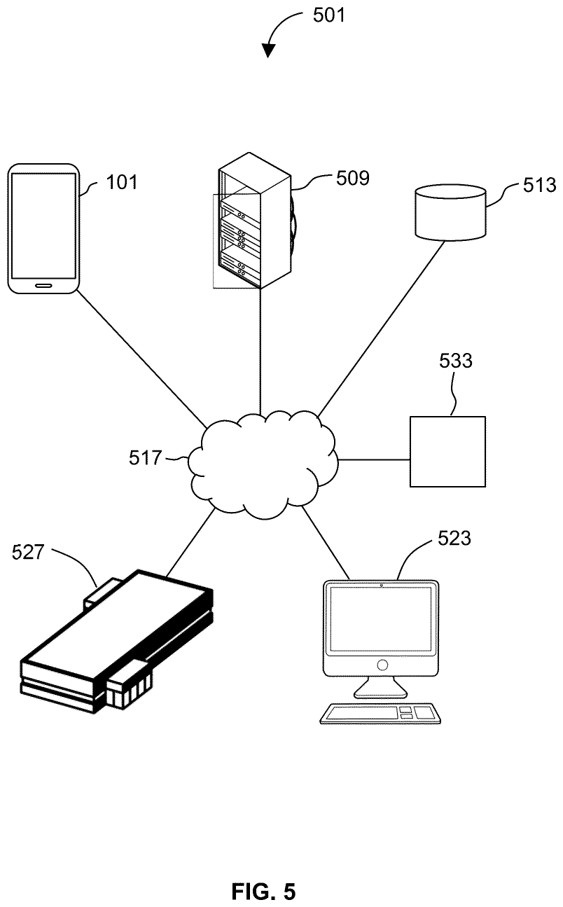

FIG. 5 depicts a system 501 of the invention. The system 501 includes a computer server system 509 that is remote from the device 101 and that communicates with the device via communications network 517. The system 501 may optionally include its own storage 513, in which data stores of real property information are stored. The system 501 may include or connect to an admin computer 523 whereby functionality of the system 501 is developed or programmed. Additionally, the system 501 is preferably able to obtain data from a third-party data provider 527, such a data broker or a government data resource. The system may also be able to obtain data from a passive or free resource such as an online database 533 or information service. For example, in some embodiments, the server computer system 509 obtains a map from a database 533 and also obtain parcel information for real estate parcels from third-party data provider 527. For example, in some embodiments, the third-party data provider 527 is Real Estate Portal, USA, in North Olmsted, OH. In certain embodiments, the third-party data provider 527 is the Federal Emergency Management Agency on C Street SW in Washington, DC, or, for example, the NC Floodplain Mapping Program in Raleigh, NC. What is important is that the third-party data providers 527 are a source of raw data that is transferred into the server computer system 509. The server computer system 509 includes at least one processor coupled to a tangible memory subsystem that includes computer program instructions to perform functionality described herein. For example, an integration module programmed into the server computer system 527 may calculate parcel dimension and features and integrate parcel boundaries on the obtained map. Other features, data types, and data sources may be fed into systems and methods of the invention. For example, the third-party data provider 527 may provide records of levels of cell tower activity. The data may be elevation data (e.g., contour maps) from mapping service. The system may depict slopes and relief on the map 109. The system may use a traffic mapping service on the device 101 that itself uses GPS-based traffic data, to estimate vehicular traffic levels and depict those on the map 109. Such functionality is provided to a user through their interaction with the user device 101. The user device 101 preferably has input mechanisms such as one or any combination of button, keyboard, mouse, or microphone and optionally a feature drawn on a capacitive touch screen such as a search bar and/or on-screen keyboard.

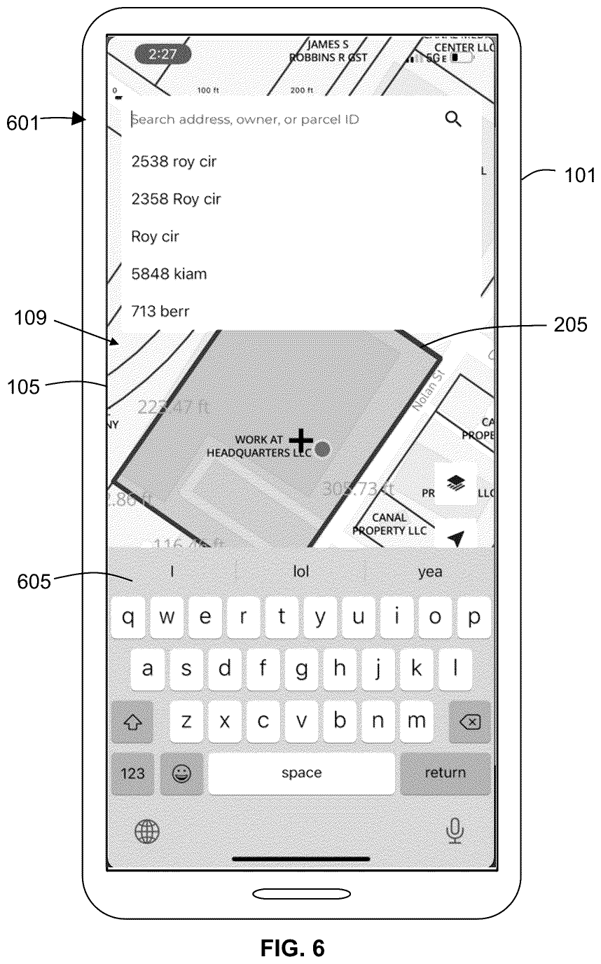

FIG. 6 shows an input mechanism on the device 101, here, a search bar 601 and accompanying on-screen keyboard 605, here shown on the display device 105, which comprises a touchscreen. The device 101 includes a processor coupled to the display device 105 and a tangible memory subsystem comprising instructions. As shown, the graphical user interface 105 includes a search tool 601 via which a user may enter search terms to inform what depicted real property information is depicted. In depicted moment captured in the image, a user has viewed a location in a commercial/industrial district of Houston, TX, and then touched the search bar 601. Touching the search bar 601 causes the on-screen keyboard 605 to appear and also brings up a drop-down list that may include recent searches and/or suggested searches. If the user touches an entry in the list in the drop-down, the device will pan the map 109 to the location retrieved by searching the selected drop-down entry. For example, if the user touches the entry for “2538 roy cir”, the server computer system will search that address and retrieve the corresponding location. Then, the server computer system will issue instructions causing the app on the device 101 to pan the view of the map 109 to the corresponding location.

That is, when the user inputs a search query into the device 101, instructions on the device 101 will be executed by the processor on the device 101 to cause the device 101 to send the user query to, and receive the real property information (e.g., location on map plus integrated parcel and flood risk renderings) from, the server computer system 509 (which itself obtains parcel data for the real estate parcels from a data provider 527 and executes the integration module to transform the parcel data into the parcel boundary lines 205 to be drawn on the map 109 along with flood risk information). Preferably, the obtained parcel data comprises a parcel boundary as a geometric shape file. The server computer system 509 calculates parcel dimensions for display on the map 109 and sends instructions to the user device causing the device 101 to display the integrated real property information responsive to the user query, that is, the parcel at 2538. Roy Circle in Houston, TX, integrated into a map view with numerical values of dimensions and flood risk information.

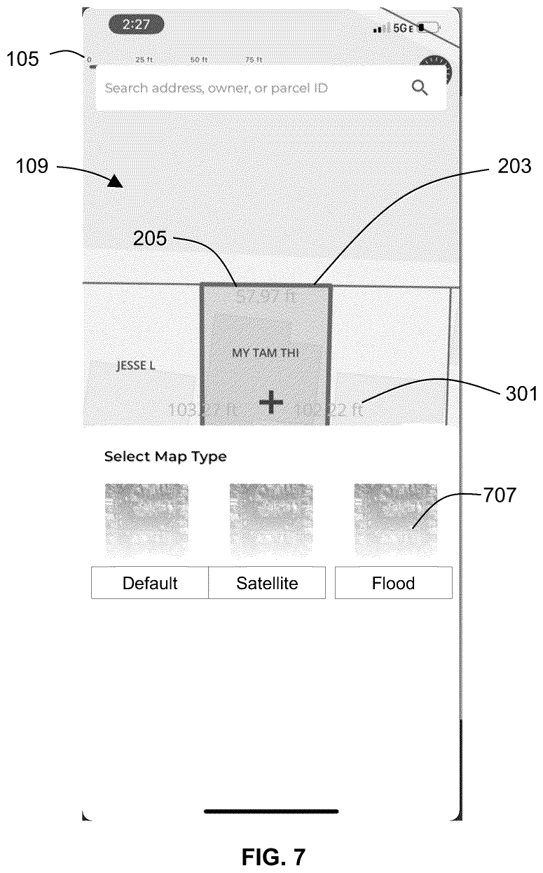

FIG. 7 shows the parcel 203 at 2538. Roy Circle in Houston, TX, integrated into a view of the map 109 with numerical values 301 of dimensions and selection button 707 to bring up flood risk information. The numerical measure 301 of a length is displayed along the parcel boundary line to which it applies. Moreover, as shown, the interface 105 on the display device allows a user to select and switch between different view types. Here, the options are for default, satellite, and flood map views, but other options could include topography or terrain, traffic (meaning trends in activity levels or live vehicular traffic levels), polling data (red/blue voters), health related information, climate or weather data, or other such map layers. Switching between those views can allow a user to gain rich information about real property including actual condition of a roof (satellite view) at some recent date, or recent building activity not reflected on default maps, or extent of overlap between actual structures present and floodplains.

One specific category of features that may be integrated onto the map 109 are indicators of traffic or activity levels. For example, the server computer system 509 may be operable to obtain records of levels of cell tower activity (e.g., historical “ping” data) and calculate a rendering that can be shown on the map 109 that gives a visual estimate of a level of a human activity at or near a given parcel 203. The server computer system 509 can instruct the device 101 to display activity levels on the map 109 based on such data as those levels of cell tower activity. For example, the remote server system 509 may transform the levels of cell tower activity into an estimate of traffic levels on the map and causes the device 101 to display the estimated traffic levels on the map, e.g., by color coding roads (e.g., red is busy, green is quiet, yellow is intermediate), allowing residential users to locate quiet roads or allowing commercial users to locate high-traffic intersections.

Other features and categories of information are within the scope of the invention. For example, the device 101 may obtain, from the remote server system 509, a record of an environmental hazard on the land and place a mark on the map showing a location of the environmental hazard. The server computer system 509 may query governmental databases of environmental quality. In another example, the device 101 may depict, for at least one of the plurality of real estate parcels 203, information showing or linking to an applicable zoning code; local demographic data; local climate zone or classification. Additionally, each parcel as depicted on the map may be interacted with by a user to pull up further information (e.g., not necessarily on the view of the map 109) about the parcel. For example, where a user is viewing a parcel with a street number of 2538 Roy Cir, the parcel itself may be presented on the display device 105 as a link that, when touched, pulls up linked property data.

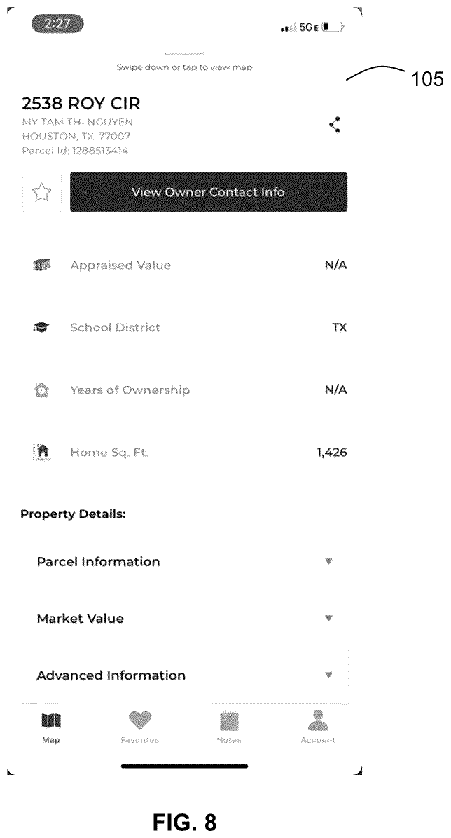

FIG. 8 shows property data that may be retrieved and displayed when a user invokes that functionality from within a map view. As shown, the user interface 105 may display any of a parcel ID, a link to owner contact information, an appraised value, a school district, years of ownership by current owner, square footage of a building, an estimate of market value, or other information. One important features of certain embodiments of methods and systems of the disclosure is that the server computer system 509 calculates dimensional information that the device 101 provides to a user.

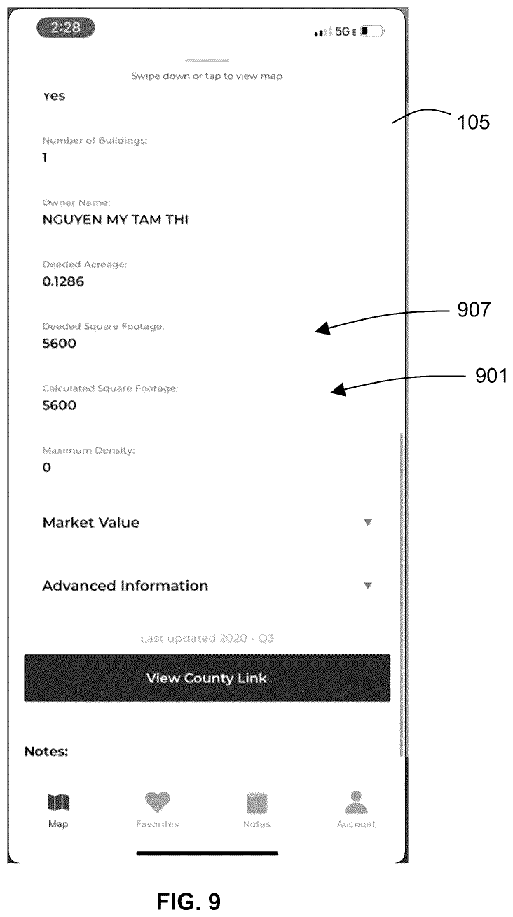

FIG. 9 shows an interface 105 that may be presented by the device 101 to show a calculated square footage value 901 that is calculated by the server computer system 509. Importantly, to illustrate the invention, the interface 105 shows a retrieved value 907 of “deeded square footage” that was retrieved from public records, such as from a county or parish registry of deeds. However, to give users an integration of the best available data, the server computer system 509 obtains parcel data as, e.g., geometric shape files, and calculates the calculated value 901 that is shown on the interface 105 that is presented to the user. The calculated value 901 and the retrieved value 907 are, in this instance, equal. Whether they are equal or unequal gives, in either event, the user valuable information for determining various things (e.g., suitability for certain construction or conservation projections, compliance with representations and warranties, compliance with area ratios or other zoning or environmental restrictions or provisions). Systems and methods of the invention do not serve any outcome or agenda, but integrate data into the most useful, reliable, and accessible form as presented here. Systems and methods of the invention are principally concerned with objective non-commercial data and facts however may include functions and features that calculate or estimate commercial values.

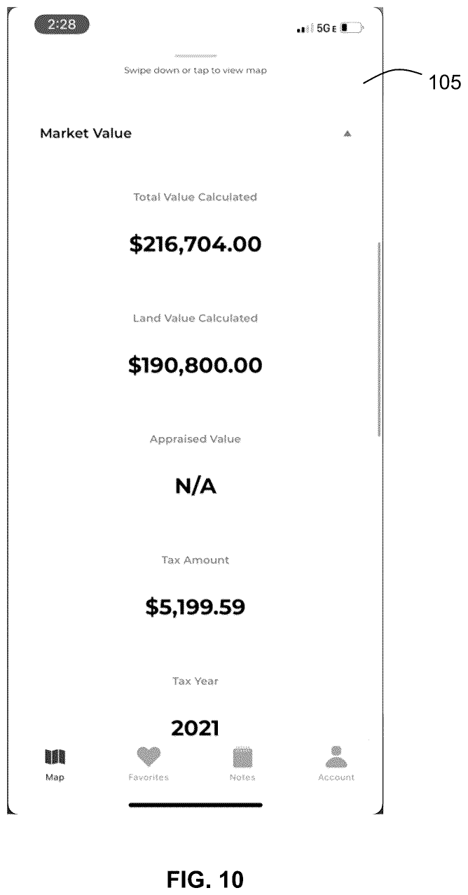

FIG. 10 shows an interface that gives values calculated for a parcel or for the land of a parcel. Importantly, these values may be calculated by the server computer system 509 independently of, but optionally influenced by, other sources that give values such as tax assessment, real-estate appraisals, proprietary algorithms in online real estate marketplaces, and human personal judgements. Thus, for example, where one of those sources estimates a parcel 203 as being presently worth, say, $201,000.00, the server computer system 509 that has integrated abundant other data not elsewhere integrated into maps (including precisely calculated parcel dimensions and flood risk information) may perform its own calculations and calculate the parcel value as $216,704.00, as depicted.

As mentioned, systems and methods of the invention are not principally a real-estate marketplace, but may include or provide tools that allow prospective buyers or sellers to find one another. As shown, the system can make estimates based on data not elsewhere integrated together. In another example, a device 101 of the invention can allow a user who is viewing real estate information about a parcel to access owner contact information.

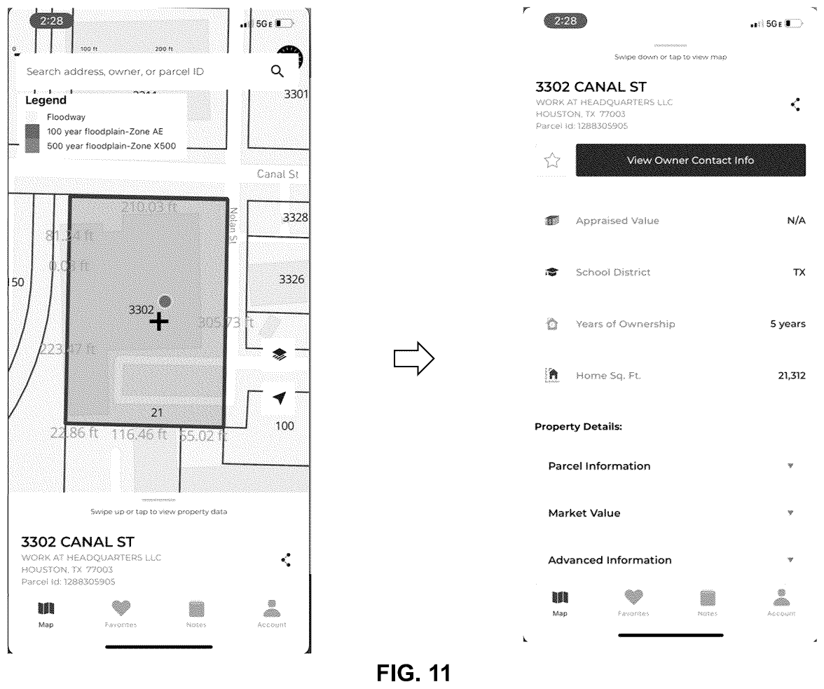

FIG. 11 shows a transition from a parcel-view/map view screen to an owner contact information screen. In preferred embodiments, owner contact information is from public databases but is filtered to exclude any person that can be found on a do-not-disturb list or a do-not-call registry. It is also noted that while owner contact information is being shown, the device 101 may also be used to display contact information to other parties such as vendors or service providers. For example, the view on the left may include a menu that expands into a list of categories (local seller agents; general contractors; environmental survey services). When a user selects one of those options, they may be taken to a screen similar to the view on the right but that offers contact information or such vendors or service providers. Those third parties may be parties that have signed-up or opted-in, or they may be search results from databases and the Internet. Thus the depicted real property information may include owner information, or a link to the owner information, for at least one of the real estate parcels shown drawn onto the map. Computer program instructions on the device 101 cause the device 101 to send user queries to, and receive the real property information from, the server computer system 509 which may itself maintain a parcel owner database 533.

The described features and hardware including the server computer system 509, the personal device 101, and the third-party data provider 517 may used to perform methods for providing integrated property information.

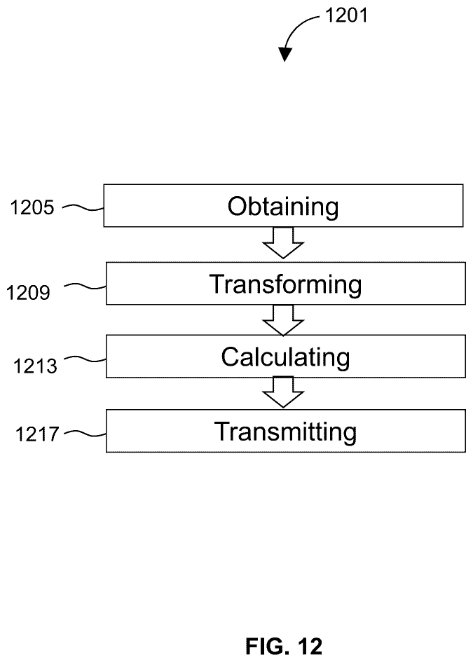

FIG. 12 diagrams a method 1201 for providing integrated property information. The method 1201 includes obtaining 1205, at the server computer system 509, parcel data for a plurality of real estate parcels 203 from a data provider 527; transforming 1209, via an integration module on the server computer system 509, the parcel data into the parcel boundary line files 205 capable of being as drawn on the map 109 of land where the real estate parcels 203 are located; calculating 1213, by the server computer system 509, dimensions that include at least a numerical measure of a length for at least one parcel boundary line; and transmitting 1217, to a user device 101, real property information to be displayed via a graphic interface on the user device, thereby causing the user device 101 to display at least a portion of the geographic map 109 of land, at least one real estate parcel 203 shown by parcel boundary lines 205 drawn onto the map 109; and the numerical measure 301 of a length displayed along the one parcel boundary line 205. Each step of the method 1201 may preferably be performed using components of the disclosed system 501. The integration module on the server computer system 509 may add to the map 109 flood risk at locations on the map of the land, such that the flood risk is depicted on the user device 101 as a floodplain 401 superimposed on the geographic map 109, the floodplain at least showing an area deemed to lie within a one hundred year floodplain. In some embodiments, software programming on the server computer system 509 causes the user device 101 to depict the flood risk using curves to mark a perimeter of the 100 or 500 year floodplain 401 (or other or both) so that, for at least one of the parcels 203, a user may see portions of the parcel within the one hundred year floodplain and portions outside of the one hundred year floodplain. Importantly, the server computer system 509 also obtains information about regulatory floodways 425 as well as floodplains 401 and may cause the user device to depict floodway markings to indicate designated floodways, wherein the floodway markings are visually distinct from the floodplain. Additionally, in preferred embodiments, the server computer system 509 receives parcel data that includes a parcel boundary as a geometric shape file, and calculates, by operations in the integration module, parcel dimensions for display on the map 109. The server computer system 509 may be provided as a desktop computer or one or more rack-mounted server computers. In some embodiments, the server computer system 509 is provided, at least in part, by a cloud computing system such as AWS that spins up as many machines as suited to the immediate task. I.e., the server computer system 509 may include a web services network that makes available a quantity of cloud computing instances in proportion to the quantity of parcel data being transformed. The integration module may attach owner information, or a link to the owner information, for at least one of the real estate parcels to be shown drawn onto the map. Additionally, the server computer system 509 may cause the user device 101 to provide any of the other functionality described herein such as providing, for any of the real estate parcels: applicable zoning code; local demographic data; local climate zone or classification; a property record transaction record, optionally wherein a property transaction record includes a deed, a lien, a property tax rate, a recorded interest, or a mortgage; or a link to a professional services provider.

The invention provides systems and methods that integrate information about real estate parcels in an intuitive and useful manner. A server system causes a user device to depict real estate parcels drawn on a map view, in which each parcel is drawn with precise boundaries and with dimensional information presented within the view. The displayed parcels are also shown with flood risk information that allows a user to see, at a granular level of detail, how different specific areas within any given parcel are affected by flood risks and associated regulatory restrictions. A device for displaying integrated property information may be a smartphone or computer that includes instructions to cause the display to present a graphical user interface depicting real property information including a map depicting roads, land-water boundaries, real estate parcels drawn onto the map; numerical measures of dimension, and flood risk information.

What is claimed is:

1. A device for viewing integrated property information, the device comprising:
a processor coupled to a display device and a tangible memory subsystem comprising instructions executable by the processor to cause the display device to present a graphical user interface depicting real property information that includes:
at least a portion of a geographic map of land, the map depicting roads present on the land and land-water boundaries;
a plurality of real estate parcels shown by parcel boundary lines drawn onto the map; and
a numerical measure of a length displayed along one or more of the parcel boundary lines.

2. The device of claim 1, wherein depicted real property information further includes flood risk at locations on the map of the land.

3. The device of claim 2, wherein the flood risk is depicted as a floodplain superimposed on the geographic map, the floodplain at least showing an area deemed to lie within a 100 year floodplain.

4. The device of claim 3, wherein the flood risk is depicted using curves to mark a perimeter of the 100 year floodplain so that, for at least one of the parcels, a user may see portions of the parcel within the 100 year floodplain and portions outside of the 100 year floodplain, optionally also including curves for a 500 year floodplain.

5. The device of claim 2, wherein the real property information further includes floodway markings to indicate designated floodways, wherein the floodway markings are visually distinct from the floodplain.

6. The device of claim 2, wherein the instructions cause the device to send user queries to, and receive the real property information from, a remote server system that obtains parcel data for the real estate parcels from a data provider and executes an integration module to transform the parcel data into the parcel boundary lines as drawn on the map.

7. The device of claim 6, wherein the obtained parcel data comprises a parcel boundary as a geometric shape file, and further wherein the remote server system calculates parcel dimensions for display on the map.

8. The device of claim 2, further operable to obtain, from a remote server system, records of levels of cell tower activity and display activity levels on the map based on the levels of cell tower activity.

9. The device of claim 8, wherein the remote server system transforms the levels of cell tower activity into an estimate of traffic levels on the map and causes the device to display the estimated traffic levels on the map.

10. The device of claim 2, further operable to obtain, from a remote server system, a record of an environmental hazard on the land and place a mark on the map showing a location of the environmental hazard.

11. The device of claim 6, wherein the remote server comprises a web services network that makes a quantity of cloud computing resources available to the integration module in proportion to the quantity of parcel data being transformed.

12. The device of claim 2, wherein depicted real property information further includes owner information, or a link to the owner information, for at least one of the real estate parcels shown drawn onto the map.

13. The device of claim 12, wherein the instructions cause the device to send user queries to, and receive the real property information from, a remote server system that maintains a parcel owner database, and further wherein the owner information is made available to a user of the device for an owner that has opted in to having their information shared on the device.

14. The device of claim 12, wherein the owner information accessible via the device is filtered to exclude persons listed on a do-not call-registry or a do-not-disturb list.

15. The device of claim 2, wherein the graphical user interface includes a search tool via which a user may enter search terms to inform what depicted real property information is depicted.

16. The device of claim 2, further operable to depict, for at least one of the plurality of real estate parcels, information showing or linking to at least one: applicable zoning code; local demographic data; local climate zone or classification.

17. The device of claim 2, further operable to, for at least one of the plurality of real estate parcels, link a user to property records including one or more of a deed, a lien, a property tax rate, a recorded interest, and a mortgage.

18. The device of claim 2, further operable to provide a user with links to a service provider optionally selected from an architect, a land surveyor, an environmental studies firm, optionally searchable by an address of a selected parcel.
